(19) United States
(12) Patent Application Publication
(10) Pub. No.: US 2005/0227198 A1
(43) Pub. Date: Oct. 13, 2005

(54) Combination dental mirror and measurement gauge

(76) Inventor: Howard Martin, Rockville, MD (US)

Correspondence Address: Royal W. Craig;Law Offices of Royal W. Craig, Suite 153, 10 N. Calvert Street, Baltimore, MD, 21202, US

(21) Appl. No.: 10/821,693

(22) Filed: Apr. 10, 2004

(51) Int. Cl. A61C 3/00

(52) U.S. Cl. 433/31

(57) ABSTRACT

A multi-purpose dental tool integrating a dental measuring gauge into the elongated shaft of a conventional dental instrument (i.e. dental mirror). The elongated shaft of the dental mirror is formed with a channel or groove that extends from a flat end (opposite the dental mirror) approximately 30 mm lengthwise along the shaft. The groove is for receiving a root canal file having a stopper along its body indicating depth of penetration into a root canal until the apical foramen. The file is inserted into the groove until the stopper abuts the flat end of the shaft. The groove is further marked with measuring lines for accurately measuring the length of the file within the groove.

### CROSS-REFERENCE TO RELATED APPLICATIONS

The present application derives priority from U.S. Provisional Patent Application No. 60/461,582 for “COMBINATION DENTAL MIRROR AND MEASURING GAUGE”; Filed: Apr. 8, 2003.

### BACKGROUND OF THE INVENTION

1. Field of the invention

The invention relates to dental instruments and, more particularly, to a dental mirror having a handle end equipped with a measuring gauge particularly suited for measuring a length of root canal file up to an attached stopper, thereby indicating the depth of penetration of a root canal.

2. Description of the Background

The standard dental mirror, magnified or plain, with a round 22-24 mm in diameter circular mirror surface attached to a handle at an angle of approximately 45 degrees, is necessary in the practice of dentistry to indirectly view hard-to-see areas within a patient's mouth, during examination or treatment. Such dental mirrors are essential during root canal therapy (endodontic treatment) to view the treatment area.

Typically, by viewing into the occlusal prepared access cavity, the dentist uses a dental mirror and a dental explorer (pick) to locate and penetrate the root canal orifice opening. This is followed by the dentist placing a root canal file, into the opening and penetrating the canal only to its apical extent, the apical foramen, without perforating the apical foramen and entering the surrounding periapical tissue and bone. Perforation of the apical foramen exposes the patient to the possibility of pain, swelling and infection. The depth of penetration is measured and the file is removed. An accurate measurement is required to insure complete penetration to the apical extent of the root canal without perforation of the apical foramen.

A typical and yet makeshift way of measuring the file penetration length is to place a rubber stop on the tip of the file with ends of the file and stopper flush, and to insert the file into the access cavity. The surface of the tooth urges the rubber stop backwards along the file as the file is inserted. Once the file is fully inserted, it is withdrawn and the distance traveled by the rubber stopper from the tip of the file is indicative of the depth to which the root canal is penetrated. Millimeter rulers are used to measure this depth of penetration.

More sophisticated devices have been developed to help in measuring penetration. For example, in effort to make the file and the millimeter ruler easier to manipulate, a millimeter ruler which attaches to the finger by a ring has been developed. Also, the millimeter ruler has been integrated with the dental mirror, in an effort to reduce the number of separate instruments, which must be handled. The RMH Integrator® by Moyco Union Broach™ Company incorporates a millimeter ruler and the mirror. Specifically, the millimeter ruler is fixed in perpendicular relation to the shaft of the mirror instrument. In order to use this instrument, the millimeter ruler portion is aligned with the portion of the file which has not penetrated the root canal and the measure of its length is deducted from the overall length of the file to determine the length of the patient's root canal. Unfortunately, when the instrument is being used as a dental mirror, the perpendicular millimeter ruler portion is an awkward extension.

A more simplified approach has also been used. Millimeter rule markings have been stamped or inscribed on the handle of the dental mirror. This type of measuring instrument suffers from the fact that the mirror handles are typically rounded so they may be easily held at any angle. The measurement must be made by aligning the file with the rounded mirror handle and reading the markings, which correspond with the end of the file and the edge of the rubber stop. The rounded shape of the handle and the light reflecting from the surface, which is usually metal, make it difficult to obtain an accurate reading.

Therefore, there is a need for a multi-purpose tool for use during endodontic treatment that integrates a conventional dental mirror and a device for measuring the depth of penetration of a root canal file into the root canal. It would be advantageous over the prior art to provide a such a single multi-purpose instrument that can easily and efficiently be used as a dental mirror and also be used to accurately measure the depth of penetration of the root canal. It would be advantageous over the prior art if this all-in-one instrument did not require additional extensions, over the configuration of a standard dental mirror, which might effect positioning of the instrument within the patient's mouth. In addition it would be advantageous over the prior art if the file could be easily stabilized by the instrument in order to obtain an accurate measurement and if the measurement markings upon the instrument were clearly visible.

### SUMMARY OF THE INVENTION

It is an object of the present invention to provide a multi-purpose dental tool that unobtrusively integrates a streamlined measuring device and a conventional dental mirror.

It is another object to provide such a tool that maybe used as a conventional dental mirror.

Another object of the present invention is to provide such a tool with ruler markings which may be used to measure the depth to which a root canal file has penetrated a patient's root canal to the apical foramen, when using the file/rubber stopper procedures discussed above.

Another object of the present invention is to provide such ruler marking which may be used to measure the depth of root canal penetration without requiring arithmetic calculations to obtain the correct result.

It is another object to provide such a tool with ruler markings that can be easily read to obtain an accurate result.

Lastly, is an object of the present invention to provide a means of securing the root canal file to the tool of the present invention when measuring depth of penetration against the ruler markings in order to obtain an accurate measurement.

According to the stated objects, the present invention is a multi-purpose dental tool combining a dental mirror and measurement gauge. The tool includes a shaft, preferably rounded in cross-section. On one end of the shaft is mounted a dental mirror, preferably a front surface 22-24 mm diameter circular mirror angled at approximately 45 degrees. The opposite end of the shaft is defined by a flat end surface perpendicular to the length of the shaft and a semi-circular groove running along the side of the shaft for a distance of approximately thirty millimeters from the flat end. The groove is of a shape and size to receive and secure the end of a root canal file. Measuring lines in millimeters are marked along the length of the groove. In use, a root canal file with an attached rubber stopper (indicating the depth of the apical foramen) is placed within the groove such that the rubber stopper abuts the flat end of the shaft. The length of the file from the flat end of the shaft to its end point within the groove can easily be measured by observing the provided markings.

Alternatively, the flat end of the shaft may open into an internal channel, running lengthwise along the shaft for approximately 30 mm. At least a portion of the shaft is comprised of a transparent outer surface such that the internal channel is visible, with measuring lines marked along the length of the channel.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a front perspective view of the combination dental mirror and measurement gauge of the present invention.

FIGS. 2 and 3 are sequential a perspective views of the combination dental mirror and measurement gauge as in FIG. 1, illustrating the method of measuring a conventional root canal file.

FIG. 4 is a perspective view of an alternative embodiment of the present invention, further illustrating the method of measuring a conventional root canal file.

FIGS. 5a and b illustrate a typical root canal file fitted with a stopper before and after insertion into the root canal, respectively.

### DETAILED DESCRIPTION OF THE PREFERRED EMBODIMENTS

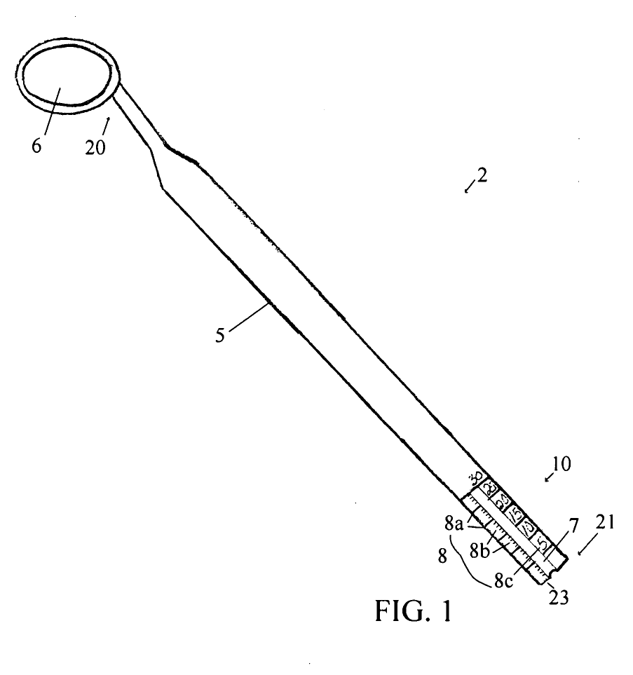

Referring in combination to FIGS. 1-3, the present invention is multi-purpose dental tool 2 integrating a conventional dental instrument of a type having an elongated handle (shaft), such as a standard dental mirror 6, and an accurate measuring device 10 integrated into the shaft 5. While the multi-purpose tool 2 of the present invention is describe herein as a combination dental mirror 6 and measuring gauge 10, those skilled in the art will recognize that measuring gauge 10 described below can be integrated into any dental instrument having an elongated handle.

The multi-purpose tool 2 of the present invention as shown in FIG. 1 comprises a shaft 5, preferably cylindrical in shape, having a first end 20 and a second end 21. A dental mirror 6 is formed on the first end of the shaft 5. It is preferred that the dental mirror 6 include a front reflective surface, plain or magnified, type having a circular shape with a diameter of approximately 22-24 mm and that it be mounted so that the plane of the mirror surface is raised and forms an angle of (i.e. approximately 45 degrees) with the shaft 5. This configuration is known as the contra angle style and provides easy viewing as well as serves to eliminate the collection of debris at the point of attachment between the mirror 6 and shaft 5.

The second end 21 of shaft 5 further comprises a flat surface 23 aligned along a plane perpendicular to the longitudinal axis of the shaft 5. In accordance with the present invention a measuring device 10 is incorporated into the second end 21 of the shaft 5. Opening onto the flat surface 23 is a channel, which in the illustrated embodiment is a straight groove 7 that extends along the length of the shaft 5 for a distance of approximately thirty millimeters. This 30 mm length is calculated to accommodate most conventional root canal files as described below with varying lengths. The groove 7 is preferably semi-circular in shape with a 1 mm diameter and 0.5 mm radius to conform to and receive a conventional root canal file 100, albeit the shape and diameter of the groove may vary depending upon the shape and size of root canal file 100 anticipated. The outer surface of the shaft 5 adjacent to the groove 7 is marked with measuring lines 8 spaced in millimeter (or other) increments. The measuring lines 8 can be applied to the surface of the shaft 5 in permanent ink media or inscribed, molded, or otherwise etched into the shaft 7 surface. The measuring lines 8 are preferably subdivided into major and minor intervals extending along the 30 mm gauge. For example, the measuring lines 8 may be marked with major intervals 8a (i.e. every 5 mm) that are either longer or broader or both than minor intervals 8b (i.e. every 1 mm). The major intervals 8a are also preferably labeled with numerals 8c to assist the user with reading a measurement. The measuring lines 8 are applied and labeled such that the measuring line occurring at a particular point denotes the accurate distance from the second end 21 of the shaft 5.

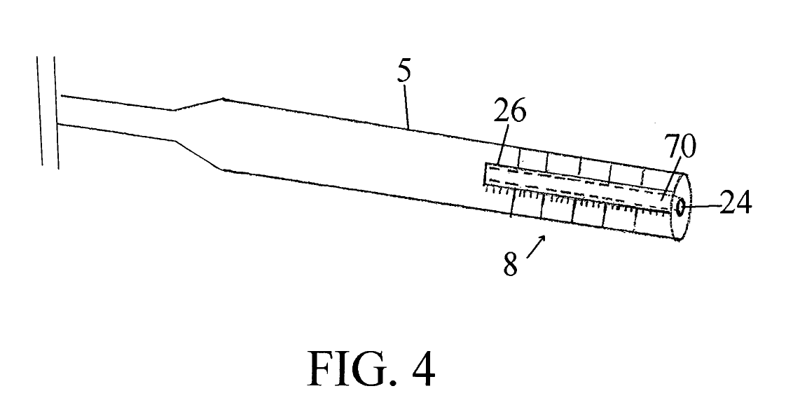

In an alternative embodiment (See FIG. 4), the multi-purpose tool 2 is formed with a central and preferably circular channel 70 opening into the second end 21 of shaft 5 with a 1 mm diameter opening at aperture 24 onto the flat end 23 and extending the length of the shaft 5 approximately 30 mm. Sections of the outer surface of the shaft 5 and of the channel 70 are configured to be transparent (i.e. window 26 of transparent plastic) so that the interior of the channel 70 is visible and the length of the file 100 inserted into the channel 70 may be measured.

Both above-described embodiments of the shaft 5 may be formed of materials that are autoclavable and chemiclavable for re-use. Suitable materials include fiberglass, plastic, ABS plastic, glass filled resin, stainless steel, nickel chrome steel, and polymers. However, a disposable tool 2 is also anticipated.

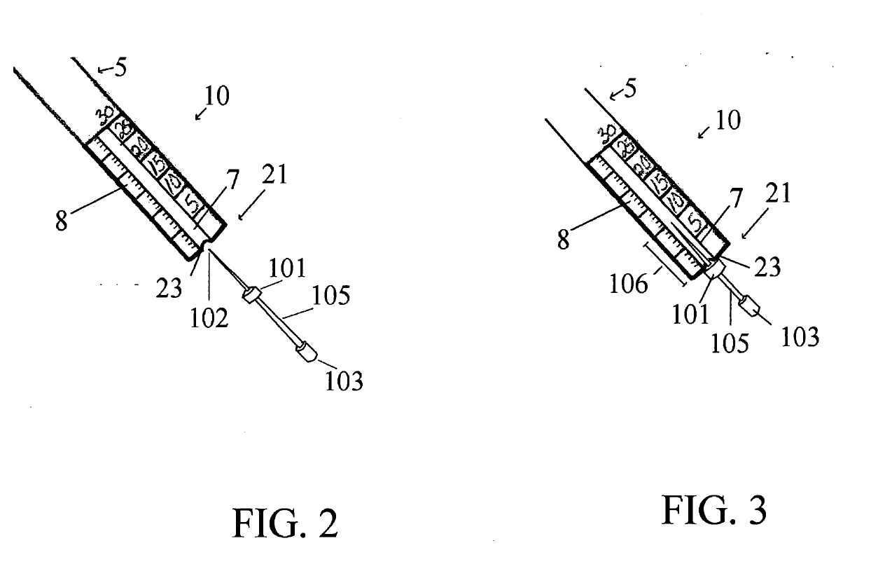

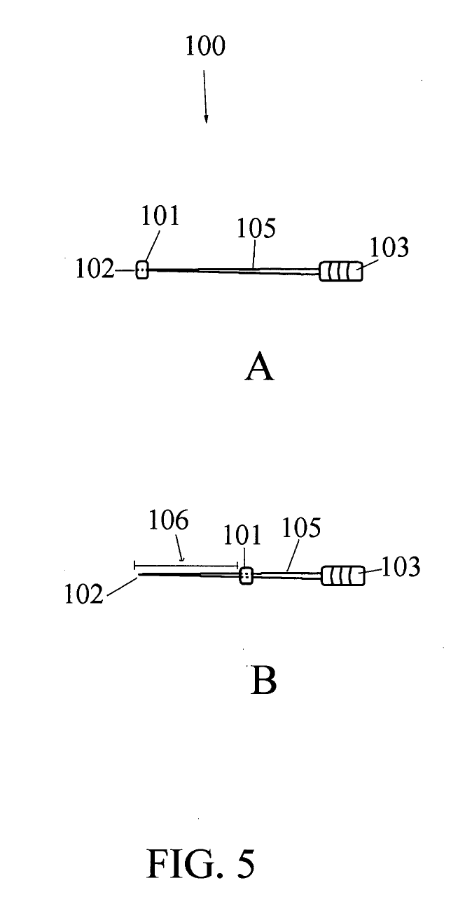

In use of the above-described embodiments, FIGS. 5a and b illustrate a typical root canal file 100 fitted with a stopper 101 before and after insertion into a root canal (not shown), respectively. A typical root canal file 100 is a long thin device having a body 105 (i.e. steel bar) with a pointed end 102 and a finger grip 103 at the other end. Root canal files 100 are available in a variety of lengths, including 21 mm, 25 mm, and 29 mm, as well as shapes (i.e. S-files, K-files, H-files, Reamers, etc.) As discussed in the “Description of the Background” section above, during root canal procedures a root canal file 100 is fitted with a rubber stopper 101 flush with is pointed end 102. In performing root canal therapy, the dental mirror 6 is used to view the insertion of the root canal file 100 into the root canal. As the file 100 enters the canal, the stopper 101 is pushed backwards along the file bar 105. Once the file 100 has penetrated the root canal to the apical foramen, the file is removed. The distance (l=106) that the stopper 102 traveled along the body 105 is equal to the depth of penetration to the apical foramen. The measuring device 10 of the present invention is designed particularly to measure this distance l (106). To use the measuring device 10, an operator will slide the root canal file 100, pointed end 102 first into groove 7 (as shown in FIG. 2) until bar 105 lies flat within the groove 7 and the stopper 101 abuts the flat end 23 of the shaft 5 (as shown in FIG. 3). Positioning the file 100 within the groove 7 secures the file for accurate measuring. The operator will note the length of the file 100 within the groove 7 using the markings 8 (8a-c), and thus the depth of penetration of the root canal to the apical foramen. Thus, there is no need to handle a separate instrument or to adjust any part of the measuring device before the measurement can be taken.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth herein.

1. A multi-purpose dental tool, comprising:
a handle formed as an elongate shaft having an operative first end and a second end; and
a measuring device comprising a channel formed in said shaft and opening to the second end, and measuring lines equally-spaced along said shaft proximate said channel for demarcating an extent of said channel relative to said second end.

2. The multi-purpose dental tool of claim 1, wherein said channel is dimensioned to accommodate insertion of a root canal file, and said measuring lines provide a visual indication of an extent to which a root canal file is inserted therein.

3. The multi-purpose dental tool of claim 2, wherein said measuring lines are marked in millimeters with major intervals marked at every 5 millimeters.

4. The multi-purpose tool of claim 2, wherein the operative first end of said dental tool is a dental mirror for use in viewing penetration of the root canal file into the root canal.

5. The multi-purpose tool of claim 4, wherein said dental mirror is circular mirror having an approximate 22-24 mm diameter and mounted on said elongated shaft at an angle of approximately 45 degrees.

6. The multi-purpose dental tool of claim 2, wherein said channel further comprises an open-faced groove extending into the second end of said shaft.

7. The multi-purpose dental tool of claim 6, wherein said groove extends into the second end of said shaft approximately 30 mm lengthwise along said shaft adjacent said measuring lines, for receiving and measuring said root canal file.

8. The multi-purpose dental tool of claim 7, wherein said groove is semi-circular in shape with a diameter of approximately 1.0 mm and a radius of approximately 0.5 mm.

9. The multi-purpose dental tool of claim 2, wherein said channel comprises an internal channel for receiving and measuring said root canal file, and said shaft further comprises a transparent window for viewing a root canal file inserted into said channel.

10. The multi-purpose dental tool of claim 10, wherein said internal channel is cylindrical in shape having a diameter of approximately 1.0 mm.

11. The multi-purpose dental tool of claim 3, wherein said shaft is formed from an autoclavable and chemiclavable material consisting of one from among the group of fiberglass, plastic, ABS plastic, glass filled resin, stainless steel, nickel chrome steel, and polymers.

12. A dental instrument for measuring a distance, comprising:
a shaft having a channel, for receiving a portion of a root canal file, running approximately thirty millimeters along its length and opening to an end of said shaft, said channel having a width and depth of sufficient dimensions to freely receive a root canal file and allow for a root canal file to freely slide along the length of the channel;
measuring lines marked on a top surface of said shaft along the length of said channel and adjacent to said channel for providing a visual indication of an extent to which said root canal file is inserted into said channel relative to the open end of said shaft.

13. The dental instrument for measuring a distance as in claim 1, further comprising an operative head portion of said dental instrument mounted on an end of said shaft opposite the channel.

14. The dental instrument of claim 13, wherein the head portion comprises a front surface dental mirror.

15. The dental instrument of claim 13, wherein the channel is approximately 1.0 millimeter in width and approximately 0.5 millimeters in depth.

16. A method for measuring a depth of penetration of a conventional root canal file into an apical foramen, comprising the steps of:
fitting a stopper on one end of said root canal file;
inserting said root canal file into a root canal until it reaches the apical foramen, said stopper being urged backward along the root canal file during insertion, a distance traveled by the stopper along the length of said file during insertion corresponding to a depth of penetration;
removing said root canal file from said root canal with stopper intact;
inserting said root canal file into a channel formed along a handle of a dental tool, said channel being demarcated with measuring lines equally-spaced along said shaft proximate said channel;
observing said measuring lines corresponding to the distance traveled by the stopper along the length of said file during insertion into said root canal to ascertain a depth of penetration therein.
